(19) United States
(12) Patent Application Publication
(10) Pub. No.: US 2011/0035674 A1
(43) Pub. Date: Feb. 10, 2011

(54) RECOMMENDATIONS MATCHING A USER'S INTERESTS

(75) Inventors: Kathi Chenoweth, Schererville, IN (US); Ravi Banda, Fremont, CA (US); Sally Baggett, Healdsburg, CA (US); Chaya Bijani, Fremont, CA (US); Gopi Jaggavarapu, Fremont, CA (US); Nancy Lang, Palatine, IL (US); Vinay Vegunta, Fremont, CA (US)

Correspondence Address: Trellis IP Law Group/Oracle, 1900 Embarcadero Road, Suite 109, Palo Alto, CA, 94303, US

(73) Assignee: Oracle International Corporation, Redwood Shores, CA (US)

(21) Appl. No.: 12/537,106

(22) Filed: Aug. 6, 2009

(51) Int. Cl. G06F 3/00

(52) U.S. Cl. 715/745

(57) ABSTRACT

Particular embodiments generally relate to providing recommendations to users. In one example, profile information from a user is received. Profile information may be received in a section of a user's profile, such as an areas of interest section. The profile information is used to determine content that might be of interest to the user. For example, content that is tagged with similar tags to the areas of interest is determined. A recommendation is generated for the user based on the determined content. The recommendation may be determined automatically based on the profile information without a query from the user. Recommendations may then be displayed for a user. For example, the recommendations may be displayed on a profile page in which the user has input the profile information.

### BACKGROUND

Particular embodiments generally relate to providing recommendations.

In an enterprise organization, employees are overwhelmed with the amount of information that may be available to them. Oftentimes, an organization is so large that an employee may not be aware of information that has been published by his/her co-workers, such as a document that might be useful for a current project or a wiki that is related to an area of interest to the user. The employee may have a few places in a preferred area to look for information, but the employee rarely looks outside of these places. In some other cases, an e-mail might be sent that may include information that is useful to the employee. However, this depends on being on the right e-mail distribution list to be informed of the new content. Typically, information is not effectively shared across the organization.

The employee can use search tools to search for new published content. However, sifting through the search results may be very time consuming with the number of blogs and wikis available. The employee would need to execute daily searches to keep up with the latest content and there is no guarantee the worker would be able to find the desired content easily. These tasks become unwieldy, especially if the worker has multiple interests.

### SUMMARY

Particular embodiments generally relate to providing recommendations to users. In one example, profile information from a user is received. The user may be associated with an organization, such as the user may work for the organization. Profile information may be received in a section of a user's profile, such as an areas of interest section. The areas of interest section may indicate certain information that a user is interested in.

The profile information is used to determine content that might be of interest to the user. For example, content that is tagged with similar tags to the areas of interest is determined.

A recommendation is generated for the user based on the determined content. The recommendation may be determined automatically based on the profile information without a query from the user. Recommendations may then be displayed for a user. For example, the recommendations may be displayed on a profile page in which the user has input the profile information.

In one embodiment, a method is provided comprising: receiving profile information from a user for an organization, the profile information related to the user's interests on a profile page for the organization; determining content related to the profile information, the content determined to be of interest to the user based on the profile information; generating a recommendation for the user based on the content, the recommendation being generated automatically in response to receiving the profile information from the user; and displaying the recommendation.

In another embodiment, a computer-readable storage medium is provided comprising encoded logic for execution by the one or more computer processors. The logic when executed is operable to: receive profile information from a user for an organization, the profile information related to the user's interests on a profile page for the organization; determine content related to the profile information, the content determined to be of interest to the user based on the profile information; generate a recommendation for the user based on the content, the recommendation being generated automatically in response to receiving the profile information from the user; and display the recommendation.

In yet another embodiment, an apparatus is provided comprising: one or more computer processors; and logic encoded in one or more computer readable storage media for execution by the one or more computer processors. The logic when executed is operable to: receive profile information from a user for an organization, the profile information related to the user's interests on a profile page for the organization; determine content related to the profile information, the content determined to be of interest to the user based on the profile information; generate a recommendation for the user based on the content, the recommendation being generated automatically in response to receiving the profile information from the user; and display the recommendation.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a system for providing recommendations according to one embodiment.

FIG. 2 depicts an example of a profile page according to one embodiment.

FIG. 3 shows an example of a profile page where recommendations are displayed according to one embodiment.

FIG. 4 depicts a more detailed embodiment of recommendation generator according to one embodiment.

FIG. 5 depicts a simplified flowchart of a method for providing recommendations according to one embodiment.

### DETAILED DESCRIPTION OF EMBODIMENTS

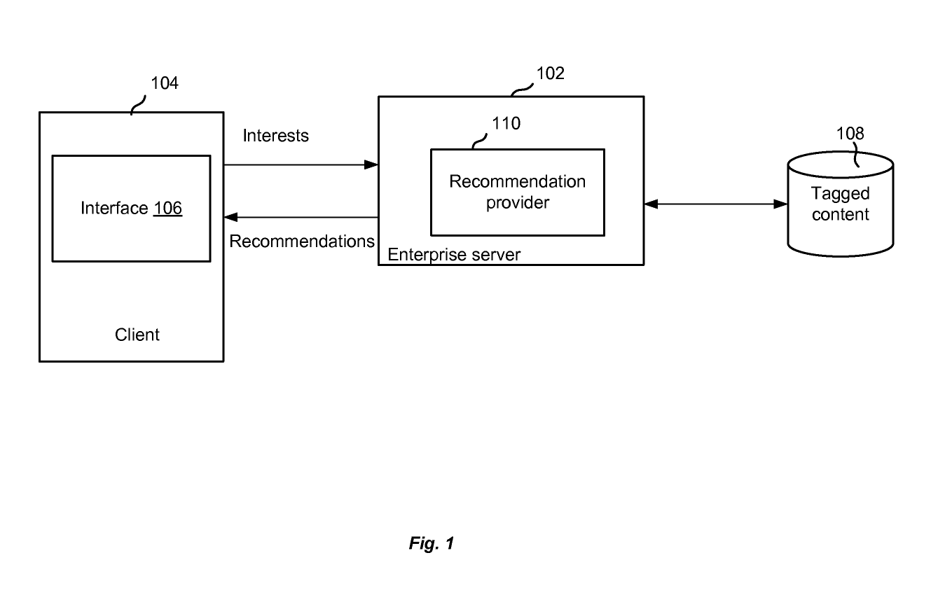

FIG. 1 depicts an example of a system 100 for providing recommendations according to one embodiment. An enterprise server 102 may be any number of computing devices that are configured to provide recommendations to a user. Although one computing device is shown, it will be recognized that functions of enterprise server 102 may be distributed among many computing devices. Although an enterprise server is shown, it will be understood that clients may perform the processing that is described with respect to the server.

In one embodiment, enterprise server 102 may be part of an intranet or proprietary network for the enterprise organization. An organization may be a related group of users employed by the organization. For example, an organization may be a company or corporation. The company may include a number of employees, which may use and have access to the intranet. The intranet may be specific to the organization's employees in that only the employees or authorized users may access the intranet. In other embodiments, enterprise server 102 may be a public server and the users are not employees of a corporation. For example, the users may be using a social network, website, etc. However, the social network or website may be a closed network in that user's login to use the network.

A user may be using a client 104, which may be any computing device, such as a personal computer, workstation, cellular phone, smart phone, laptop computer, etc. An interface 106 may be used to display provide profile information and recommendations.

The profile for the user may include different information that employees of the organization may provide. For example, the profile includes sections for contact information, experience and qualifications, and activities and interests. Other sections such as a social network, message board, or kudos may be provided. The profile may serve as a home page that provides information that other employees of the organization can view.

The home page may also include information in which the user is interested. In one embodiment, profile information, such as a user's areas of interest, are sent to enterprise server 102 for providing recommendations. In other embodiments, profile information from other sections is sent to recommendation provider 110.

Recommendation provider 110 is configured to determine recommendations for the user. In one example, content that is stored in a database 108 is determined to be of interest to the user based on the areas of interest. In one embodiment, the content may be tagged with keywords or other information. The tags describe the content and can be used to determine the recommendation. Also, the profile information may be converted into tagged content (from the current user and from other users).

In one embodiment, the recommendations may be provided automatically in response to a user entering in profile information in the areas of interest. For example, the recommendations may be pushed to a user based on the areas of interest entered. Thus, the user may not be submitting a query for the recommendations. Rather, the user generates a profile that is being used by the organization. The user may enter information in areas that are of interest to him/her in his/her profile. Recommendations are then automatically determined for the areas of interest. A search button may not be selected by the user to initiate a search. Rather, the user enters information in the section of the profile.

Recommendation provider 110 is then configured to provide the recommendation to the user. For example, content that is tagged similarly is determined as recommendations. The recommendations may be content based on informational tags and user tags. Informational tags may be used to recommend informational content (e.g., informational sources) and the user tags may be used to recommend people. The recommendations may then be displayed on the user's profile page in interface 106.

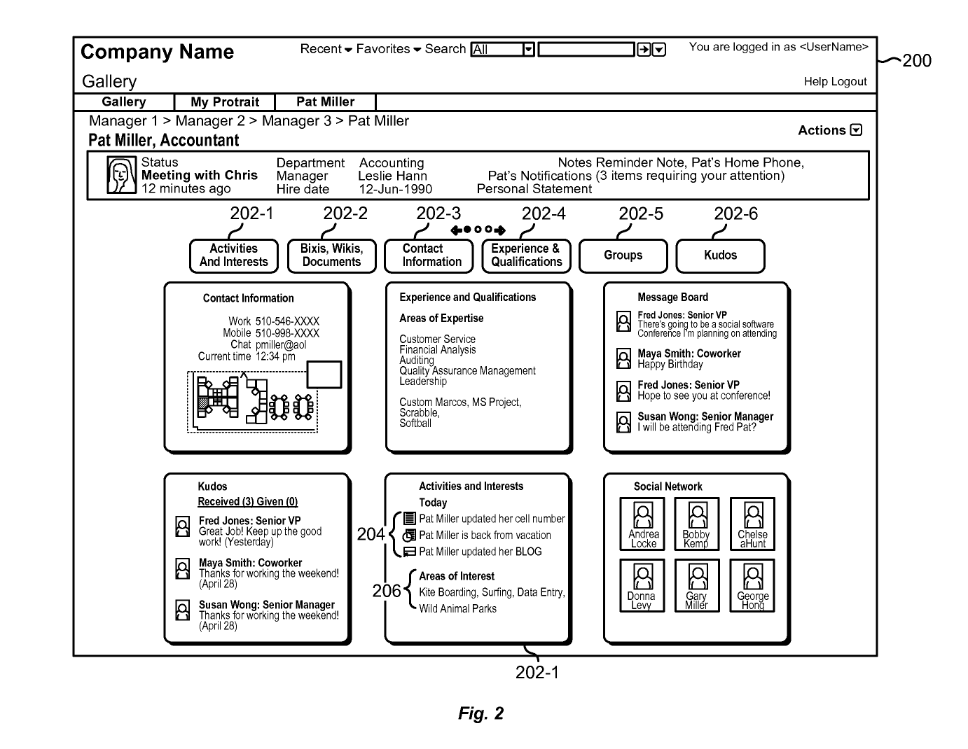

FIG. 2 depicts an example of a profile page 200 according to one embodiment. Page 200 may be a profile generated within an organization and may be found on the organization's intranet or any other proprietary network. In this case, a user, Pat Miller, has created a profile page. It will be expected that other employees of the organization will have similar profile pages.

Different information may be provided in sections 202-1-202-6. This information may be input by the user or automatically provided. For example, the contact information in section 202-3 may be input to allow other employees to contact the user.

Any of sections 202 may be used to provide profile information to recommendation provider 11 O. However, in one embodiment, activities and interests section 202-1 is used to provide the profile information. Areas of interest 206 show interests of the user. The areas of interest may be input by a user and may include various items that a user is interested in, which may be either social and/or work related interests. In this case, kite-boarding, surfing, data entry, and wild animal parks have been provided. Also, an activities section 204 shows the activities that a user has recently been involved with. This section may be used to provide recommendations, such as recommendations for people that have related activities.

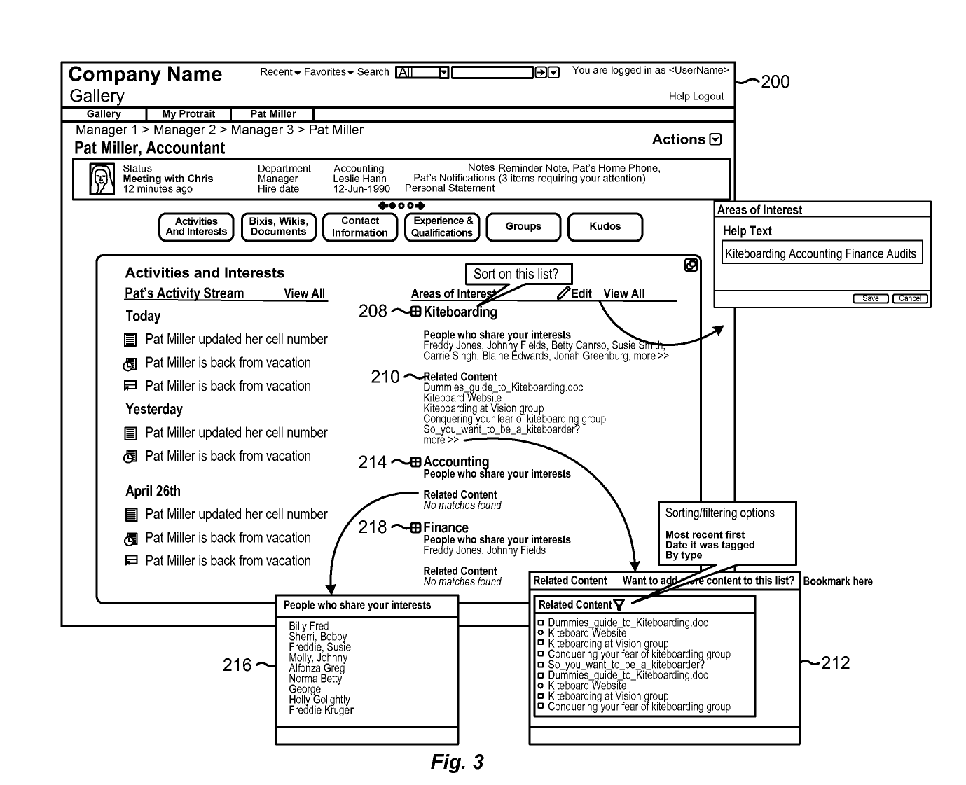

When the user submits his/her areas of interest, recommendations may be provided. FIG. 3 shows an example of interface 200 where recommendations are displayed according to one embodiment. In areas of interest section 206, different recommendations are displayed. The recommendations may be user or informational recommendations. For the interest of kite-boarding in section 208, different people who share the user's interest in kite-boarding are shown. These are people who may have tagged content associated with kite-boarding. For example, Freddie Jones et al. may have indicated that kite-boarding is an area of interest. Also, these users may have published content on kite-boarding that was tagged. The users are determined based on the tagged content and provided as people who share the kite-boarding interest.

In a related content section 210, related content (e.g., informational sources) that may have been published by the organization is shown. Also, content outside of the organization may be provided, such as a search of content found in the World Wide Web (WWW) may be performed. Also, external content that was tagged by another user may be provided. For example, a search of the worldwide web for kite-boarding or for external content tagged with kite-boarding may be performed and the results of the search provided in section 210.

Sorting and filtering options may be provided for related content as shown in section 212. In this case, the content may be sorted by the most recent date on which it was tagged or by type.

The recommendations may also be broken down by other categories. For example, in section 214, people in accounting who share the same interest are shown in a box 216. Also, people in finance are shown in a section 218. This allows a user to see which departments include different people who may share the same interests.

In another embodiment, multiple dimensions may be used to determine recommendations. Instead of recommending on an exact match of tags, data mining may be performed to determine how various tags should be grouped together. The recommendations may be based on the combination of tags. For example, areas of interest from other people who like kite-boarding and surfing may be provided. These matches may be more relevant than single dimension matches. For example, a person that matches both stages may be a person that shares more interests with the user and may have more in common or more information that is of interest to the user.

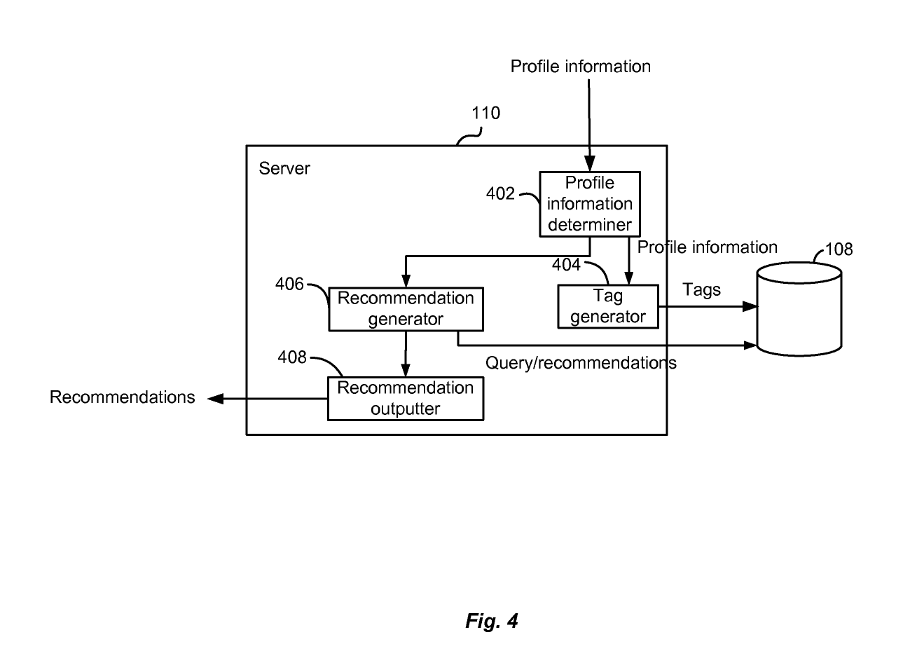

FIG. 4 depicts a more detailed embodiment of recommendation generator 110 according to one embodiment. A profile information determiner 402 is configured to receive profile information from the user. For example, each user identifies his/her areas of interest. Areas of interest is a section of the user's profile that will be viewable by others. The keywords are entered by a user and are implemented as tags. Also, the tags may be stored in database 108. For example, areas of interest may be entered as Java, marketing, recruiting, and bowling. These tags may be indexed with the users. For example, a user identifier (ID) is included with the tags such that the user can be identified as having a same interest from the tag. A search for Java would thus yield this user's ID and that user can be returned as a recommendation.

In one embodiment, the recommendations are provided based on a tagging model. However, in other embodiments, recommendations may be provided without using tags. For example, the content may be indexed and indices may be used to provide the recommendations. Also, common associations may be used where some association between content is used. Other methods such as ratings and comments on content, popularity of content, or any combination of methods may be used.

A tag generator 404 is configured to tag content. The content may be tagged automatically based on an analysis of the content. For example, a report on a specific stock may be tagged with the words “stock” and “Company name”. Also, the content may be tagged manually by other users. For example, a picture may be tagged based on the content that a user observes in the picture. Documents, blogs, wikis, and other people may be tagged and stored in tagged content. Also, tag generator 402 stores the areas of interest received from users as tagged content. This tagged content may be used to suggest this user has similar interests to other users.

Recommended content and recommended people may then be generated as recommendations. For example, recommendation generator 406 may determine a list of documents, blogs, wikis, forms, or other content that has been tagged with the terms Java, marketing, recruiting, and bowling. The recommendations are not limited to these exact tags, however. Other content that may be deemed related to those tags may be determined. For example, documents about other software languages related to Java may be determined as recommendations.

Also, recommendation generator 406 determines other users that are likely to share some common areas of interest. For example, other users that included the same interests are determined based on their areas of interest being stored as tags. Providing recommendations for other users allows them to find colleagues that have common areas of interest, which may help in networking within the organization.

Recommendation generator 406 then generates a recommendation for the user. The recommendations may be formatted for the profile page. Also, they may be organized and sorted.

Recommendation outputter 408 is configured to output/display the recommendation. For example, the tagged content may be displayed on profile page 200. The recommendations may be links in which the user may select to display the content. Also, names for the recommended people may be displayed. A user may select a person's name and then be re-directed to the person's profile. From the person's profile page, the user can contact the person or explore other items on his/her profile. This allows social networking between the user and the selected person. For example, the user can see this person's social bookmarks, activity stream, and group memberships, which may open up more avenues to explore, share information, and expand knowledge. Also, the user can see the other person's system-generated recommended content, which may also be of interest to this user because they have the same interests. A user can also initiate a mentor relationship by viewing other user's profile pages with similar interests.

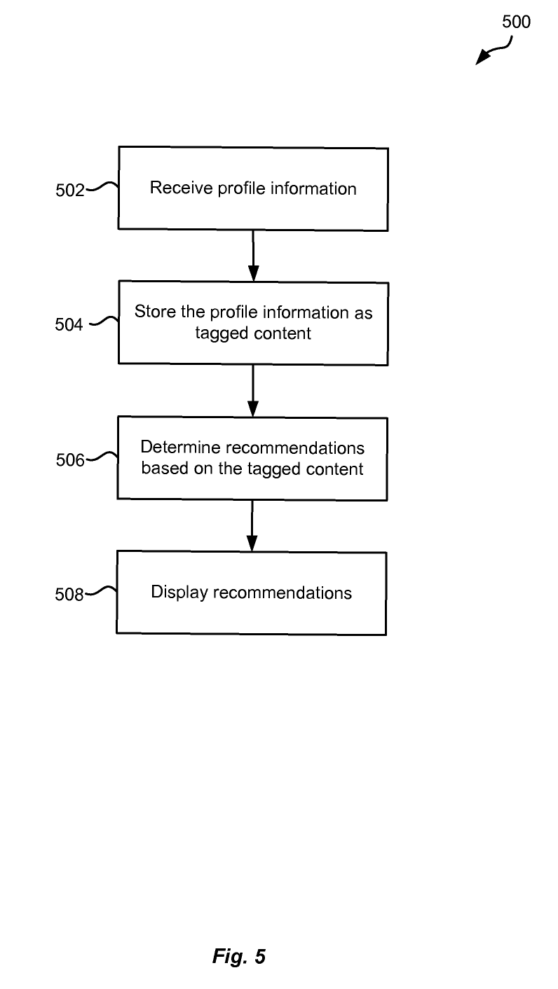

FIG. 5 depicts a simplified flowchart 500 of a method for providing recommendations according to one embodiment. In step 502, recommendation provider 110 receives profile information. The profile information may be areas of interest that have been input into a user's profile page 200. The profile information may be received at different times. For example, a user may enter in profile information and submit it on the profile page. Once submitted, the profile information is sent to server 102. Also, the profile information may be downloaded periodically.

Step 504 stores the profile information as tagged content. This tagged content may be used for providing recommendations to other users.

In step 506, recommendation provider 110 determines recommendations based on the tagged content. For example, content that has been tagged by the users with similar tags as the profile content may be determined. Also, other people that have tagged content associated with the profile tag content may also be determined. This may determine content and people that are of interest to the user.

Recommendations provider 110 may generate recommendations at different times. For example, recommendations may be generated periodically. As new tagged content is submitted to database 108, the recommendations may be refreshed for a user. Also, when a user changes his/her areas of interest, new recommendations may be generated. The recommendations may be added to previous recommendations. The user may choose to delete some recommendations after viewing them also.

In step 508, recommendations may be displayed. For example, recommendations may be displayed on a profile page 200 of a user.

Particular embodiments provide many advantages. For example, conventionally, a user would have had to manually enter search terms to manually perform searches. Now, enterprise server 102 and recommendation provider 110 automatically perform searches regularly. For example, searches may be performed periodically. The information is also pushed to the user automatically and stored on their profile page. Other methods may also be used to provide the recommendations to a user. For example, recommendations may be e-mailed to a user.

Each user's interests and recommendations are also exposed to other users. This may provide additional information for users that are browsing other users' profile pages. Thus, a user's interest may pique the interest of other users. Also, a user can not only find written documentation but also other people who match his/her interests.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
receiving profile information from a user for an organization, the profile information related to the user's interests on a profile page for the organization;
determining content related to the profile information, the content determined to be of interest to the user based on the profile information;
generating a recommendation for the user based on the content, the recommendation being generated automatically in response to receiving the profile information from the user; and
displaying the recommendation.

2. The method of claim 1, wherein the recommendation comprises recommended content, the content being an informational source.

3. The method of claim 1, wherein the recommendation comprises one or more recommended people, the one or more recommended people being users that are determined to be of interest to the user.

4. The method of claim 1, wherein determining content comprises:
determining one or more profile tags for the profile information; and
determining tagged content that matches the one or more profile tags.

5. The method of claim 4, wherein the tagged content includes user tags for one or more users that are associated with the tagged content.

6. The method of claim 4, wherein the tagged content includes one or more informational tags for informational sources associated with the tagged content.

7. The method of claim 1, further comprising:
tagging the profile information; and
storing the tagged profile information, wherein the tagged profile information is used to provide a recommendation for another user.

8. The method of claim 6, wherein the profile information is tagged with a user identifier for the user.

9. The method of claim 1, wherein the profile comprises an area of interest where information that interested the user is received as input from the user.

10. The method of claim 1, wherein the recommendation is displayed on the profile page of the user.

11. The method of claim 1, wherein the recommendation comprises a link to the informational source, the method further comprising:
receiving a selection of the link; and
providing the informational source to the user.

12. The method of claim 1, wherein recommendation comprises a link to a second user's profile page, the method further comprising:
receiving a selection of the link; and
displaying the profile page for the second user.

13. A computer-readable storage medium comprising encoded logic for execution by the one or more computer processors, the logic when executed is operable to:
receive profile information from a user for an organization, the profile information related to the user's interests on a profile page for the organization;
determine content related to the profile information, the content determined to be of interest to the user based on the profile information;
generate a recommendation for the user based on the content, the recommendation being generated automatically in response to receiving the profile information from the user; and
display the recommendation.

14. The computer-readable storage medium of claim 13, wherein the recommendation comprises recommended content, the content being an informational source.

15. The computer-readable storage medium of claim 13, wherein the recommendation comprises one or more recommended people, the one or more recommended people being users that are determined to be of interest to the user.

16. The computer-readable storage medium of claim 13, wherein the logic operable to determine content comprises logic operable to:
determine one or more profile tags for the profile information; and
determine tagged content that matches the one or more profile tags.

17. The computer-readable storage medium of claim 16, wherein tagged content comprises tagged informational content and tagged users.

18. The computer-readable storage medium of claim 13, wherein the logic is further operable to:
tag the profile information; and
store the tagged profile information, wherein the tagged profile information is used to provide a recommendation for another user.

19. The computer-readable storage medium of claim 13, wherein the profile comprises an area of interest where information that interested the user is received as input from the user.

20. An apparatus comprising:
one or more computer processors; and
logic encoded in one or more computer readable storage media for execution by the one or more computer processors and when executed operable to:
receive profile information from a user for an organization, the profile information related to the user's interests on a profile page for the organization;
determine content related to the profile information, the content determined to be of interest to the user based on the profile information;
generate a recommendation for the user based on the content, the recommendation being generated automatically in response to receiving the profile information from the user; and
display the recommendation.
